(19) United States
(12) Patent Application Publication
(10) Pub. No.: US 2008/0053810 A1
(43) Pub. Date: Mar. 6, 2008

(54) Solid-Insulated Switch Pole with an End Moving Contact Connection

(75) Inventors: Uwe Hering, Berlin (DE); Matthias Schmidt, Berlin (DE); Ralf-Reiner Volkmar, Oldenburg i.H. (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/663,690

(22) PCT Filed: Sep. 15, 2005
(86) PCT No.: PCT/EP05/54581

§ 371 Date: Mar. 23, 2007

(30) Foreign Application Priority Data
Sep. 24, 2004 (DE) 10 2004 047 259.9

(51) Int. Cl. H01H 15/06

(52) U.S. Cl. 200/540

(57) ABSTRACT

A circuit breaker pole for interrupting the electric current is insulated by a solid material and has a dimensionally stable and electrically non-conducting insulating material housing, a switching tube fastened in the insulating material housing and having a stationary fixed contact and a movable mobile contact. An input connection piece is electrically connected to the fixed contact and contactable from outside, and an output connection piece is connected to the mobile contact via a movable contact connection. The output connection piece is linked with the insulating material housing in a fixed manner and has a contact surface that can be contacted from outside. The insulating material housing has an opening for inducing a driving motion into the movable contact. The mobile contact connection is fixed to the output connection piece by connecting devices that act upon the contact surface. The circuit breaker pole is inexpensive and easy to install.

The present invention relates to a solid-insulated switch pole for interruption of an electric current, having a dimensionally stable and electrically non-conductive dielectric housing, a switching tube which is mounted in the dielectric housing and has a stationary fixed contact and a moving contact, an input connecting piece which is electrically connected to the fixed contact and with which contact can be made from the outside, and an outgoer connecting piece which is connected to the moving contact by means of a moving contact connection is firmly connected to the dielectric housing and has a contact surface with which contact can be made from the outside, with the dielectric housing being provided with an opening for introduction of a drive movement to the moving contact.

The present invention also relates to a method for connection of a moving contact connection of a solid-insulated switch pole which has a dimensionally stable, electrically non-conductive dielectric housing, a switching tube which is mounted in the dielectric housing and has a stationary fixed contact and a moving contact, an input connecting piece which is electrically connected to the fixed contact and with which contact can be made from the outside, and an outgoer connecting piece which has a contact surface with which contact can be made from the outside, with the dielectric housing being equipped with an opening for introduction of a drive movement to the moving contact, in which, once the switching tube has been introduced into the dielectric housing, the outgoer connecting piece is electrically connected to the moving contact via the moving contact connection.

An apparatus such as this and a method such as this are already known, for example, from DE 197 12 182 A1. This document discloses a solid-insulated switch pole which has a dimensionally stable dielectric housing composed of cast resin. The dielectric housing is hollow cylindrical and has a vacuum interrupter tube in its interior. The vacuum interrupter tube has a hollow-cylindrical ceramic body, which is closed in a vacuum-tight manner at both ends by metallic end caps. In this case, a stationary fixed contact rod or a moving contact rod which can move longitudinal passes through the end caps, and these are respectively fitted with a stationary fixed contact or a moving contact at their end which projects into the vacuum interrupt chamber. The moving contact is connected to the metallic end cap via a metal bellows. The fixed contact rod is in contrast firmly screwed to an input connection which is passed out the dielectric housing. The moving contact rod is connected via a flexible strip to an outgoer connecting piece, which likewise has a contact surface or surfaces with which contact can be made from the outside. The flexible strip allows the moving contact to be electrically connected to the outgoer connecting piece, while retaining the mobility of the moving contact.

In order to produce the switch pole, the switching tube is, for example, firmly encapsulated in the dielectric housing. The method results in the flexible strip being connected to the outgoing connecting piece after encapsulation through an opening in the dielectric housing, which opening is provided for introduction of a switching movement to the moving contact. In this case, the flexible strip is attached to a side of the outgoing connecting piece which faces the opening in an encapsulated state.

The already known apparatus and the already known method have the disadvantage that the dielectric housing has an enlarged internal diameter for attachment of the flexible strip. However, despite the enlarged internal diameter, it is still difficult to fit the flexible strip to the outgoer connecting piece, which is offset into the interior of the dielectric housing.

One object of the present invention is therefore to provide a solid-insulated switch pole of the type mentioned initially, which can be produced at low cost and can be installed easily.

The invention achieves this object by the moving contact connection being held against the outgoer connecting piece by connection means which act on the contact surface.

A further object of the invention is to provide a method of the type mentioned initially, which allows final assembly of the switch pole of this generic type quickly and at low cost.

The invention achieves this object in that the moving contact connection is attached to the contact surface of the outgoer connecting piece.

According to the invention, the final assembly of the solid-insulated switch pole, that is to say the connection and attachment of the moving contact connection to the outgoer connecting piece, are no longer carried out as normal in the prior art through the opening in the dielectric housing which is provided for initiation of the drive movement. According to the invention, the moving contact connection is connected to the outgoer connecting piece by means of its end contact surface. The opening in the dielectric housing can thus be designed solely for the drive mechanism. This leads to a more compact switch pole. Furthermore, the assembly of the switch pole according to the invention is simplified, since the contact surface is accessible from the outside, and thus more easily. Finally, the solid-insulated switch pole according to the invention is also cost-effective, since the components which are used for this purpose are less complex, and can thus be produced easily. It is also possible within the scope of the invention to enlarge the diameter of the switching rod which initiates the movement, or even to provide it with external ribs, in order to increase the creepage distance on an insulating switching rod.

The outgoer connecting piece advantageously has aperture openings, through which the connection means extend on its contact surface. According to this further development, the connection means are expediently in the form of a clamping connection. The clamping connection presses the outgoer connecting piece and the moving contact connection against one another, so that the necessary holding force is provided for the moving contact connection. The attachment of the outgoer connecting piece to the dielectric housing also results in the moving contact connection being held firmly on it.

According to one further development which is expedient for this purpose, the clamping connection is in the form of a screw connection. This allows the outgoer connecting piece to be easily connected to the moving contact connection which, for example, is in the form of a flexible strip. The moving contact connection for this purpose has, for example, an expedient internal thread, with a long screw being provided at its free end with an external thread which engages in an interlocking manner in the internal thread of the moving contact connection. It is, of course, also possible to use a separate nut, or a nut which is welded to the moving contact connection, instead of an internal thread in the moving contact connection.

The moving contact connection expediently has a rolling contact or a sliding contact.

The moving contact connection advantageously has at least one flexible strip, however. Flexible strips are known per se. However, their use for the purposes of the invention results in a particularly simple design, and subsequently simple assembly of the solid-insulated switch pole according to the invention.

According to one advantageous further development in this context, a plurality of flexible strips are provided, with the flexible strips being connected to the outgoer intermediate piece via a common intermediate piece. In order to fit the flexible strip to the outgoer connecting piece at the end, the flexible strip expediently has a recess or aperture opening with or without an internal thread, thus reducing the current cross-section of the conductor strip, and resulting in increased heat being developed. In order to increase the effective conductor cross-section, a plurality of flexible strips are therefore expedient, which are electrically and mechanically linked to a common intermediate piece. The intermediate piece is manufactured from a highly conductive material such as copper and has a strip section to which the flexible strips are attached, for example at the side. The strip section is provided in the mid-position with an aperture opening, through which a switching rod, which is connected to the moving contact, extends freely. For attachment to the outgoer connecting piece, the intermediate piece furthermore has an attachment section, which is expediently aligned at right angles to the holding section. In this case, the side facing the outgoer connecting piece is, for example, matched to the size of the outgoer connecting piece, so that, in the assembled state, the intermediate piece rests over as large an area as possible on the outgoer connecting piece. The intermediate piece in conjunction with the flexible strips increases the current cross-section of the moving contact connection, so that the solid-insulated switch pole can also be used for higher currents.

According to one advantageous development of the method, the moving contact connection and the outgoer connecting piece are attached to one another by means of a clamping connection.

Further expedient refinements and advantages of the invention are the subject matter of the following description of exemplary embodiments of the invention, with reference to the figures of the drawing, in which:

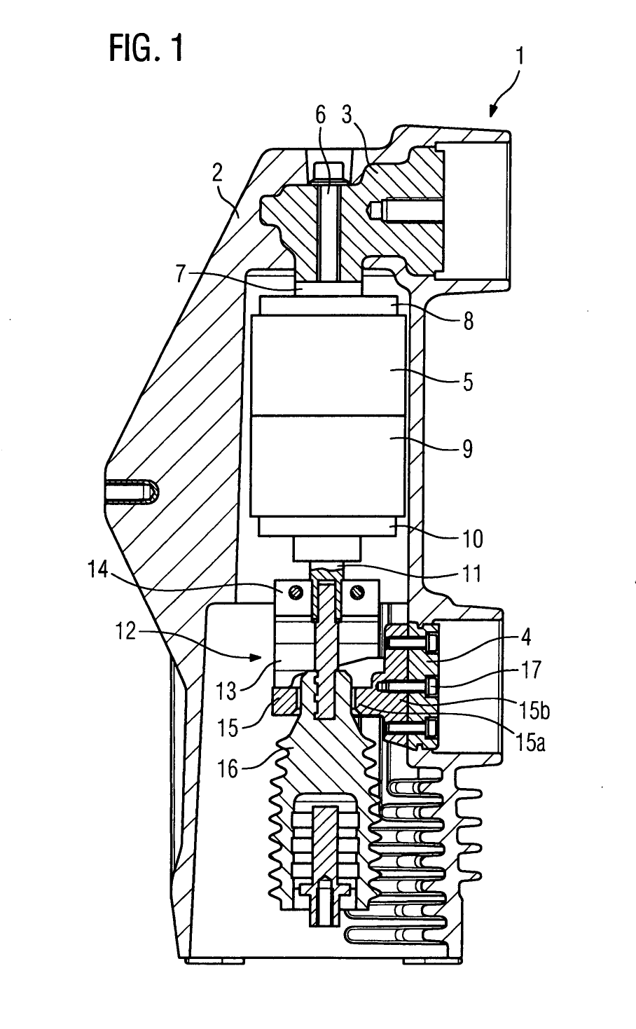

FIG. 1 shows an exemplary embodiment of the solid-insulating switch pole according to the invention, in the form of a cross-sectional view, and

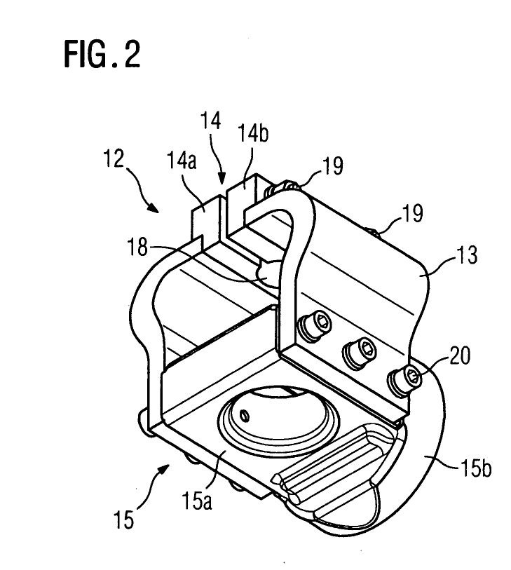

FIG. 2 shows the intermediate piece shown in FIG. 1, in the form of an enlarged, perspective view.

FIG. 1 shows an exemplary embodiment of the switch pole 1 according to the invention, in the form of a side cross-sectional view. The switch pole 1 that is illustrated has a dielectric housing 2 which is composed of cast resin and is dimensionally stable, and in which an input connecting piece 3 is encapsulated at its upper end, and an outgoer connecting piece 4 is encapsulated in the mid-position. A vacuum interrupter tube 5 is attached to the upper input connecting piece 3. A screw connection 6 is used for this purpose, which passes through an aperture opening that is provided in the input connecting piece 3, and whose free end is connected in an interlocking manner, via a thread, to a fixed contact rod 7. The fixed contact rod 7 passes through an end cap 8 at the end of the vacuum interrupter tube 5 which, together with an insulating ceramic housing 9 and a lower end cap 10 at the end, forms a switching chamber, in which there is a vacuum.

A fixed contact which is not illustrated in the figures is arranged at the free end of the fixed contact rod projecting into the switching chamber, opposite which a moving contact, which is guided such that it can move longitudinally, is arranged in the longitudinal direction. The moving contact is held by a moving contact rod 11, which passes through the lower end cap 10, with a metal bellow, which is not illustrated but is attached on the one hand to the moving contact rod 11 and on the other hand to the end cap 10, allowing a switching movement of the moving contact.

A moving contact connection 12 is provided for electrical connection of the longitudinally moving moving contact rod 11 together with the stationary outgoer connecting piece 4, with flexible strips 13 allowing movement of the moving contact rod 11 in the longitudinal direction. At their upper end, the flexible strips 13 are provided with a clamping part 14, which is firmly connected to the moving contact rod 11 and is offset upwards and downwards, that is to say in the longitudinal direction, during a switching movement. At the lower end, the flexible strips 13 are firmly connected to a stationary intermediate piece 15, which has a connecting section 15a as well as an attachment section 15b, which extends essentially at right angles thereto. An aperture opening is provided in the connecting section 15a, through which a switching rod 16, which is composed of a dielectric material, passes through. The switching rod 16 is firmly connected at its upper end to the moving contact rod 11, and by its end, averted from the moving contact rod 11, to a lever mechanism. The lever mechanism allows the drive movement produced by the drive unit to be introduced into the switching rod 16, and thus into the moving contact rod 11.

Screws 17 whose screw heads are countersunk in the outgoer connecting piece 4 are provided for attachment of the connection section 15b to the outgoer connecting piece 4. The external threads on the screws 17 engage in an internal thread in the attachment section 15b.

In the connected state, the moving contact rests against the fixed contact of the vacuum interrupter tube. This therefore allows a closed current path from the input connecting piece 3 via the fixed contact rod 7, the fixed contact, the moving contact, the moving contact rod 11 and the moving contact connection 12 to the outgoer connecting piece 4. Initiation of a switching movement disconnects the moving contact from the fixed contact, with any arc that may be struck in the process being quenched at a current zero-crossing of the alternating current in the vacuum. The solid-insulated switch pole 1 is provided for current interruption in one phase of a three-phase power supply system. Circuit breakers normally have three switch poles, so that one switch has three solid-insulated switch poles as shown in FIG. 1, which are normally arranged alongside one another at right angles.

FIG. 2 shows an enlarged perspective illustration of the moving contact connection 12. As can be seen here, the clamping part 14 is composed of two copper blocks 14a and 14b which are located opposite one another and bound a recess 18 between them, which is used to hold the moving contact rod 11. Screw connections 19 are used to clamp clamping part 14 to the moving contact rod. At there end remote from the clamping part 14, the flexible strips 13 are connected by screws 20 to the intermediate piece 15, and in this case the aperture opening for the switching rod in the connecting section 15a can be seen in the illustration that is shown. The connection between the intermediate piece 15 and the flexible strips 13 may, however, be implemented in any desired manner according to the invention. For example, it is also possible to use a welded joint, a soldered joint or the like. An attachment section 15b extends at right angles to the connecting section 15a and has a flat contact face which is complementary to the inner face of the outgoer connecting piece. The use of the intermediate piece 15 allows the use of two flexible strips 13, with a sufficiently large current cross-section being produced even for high currents.

1-8. (canceled)

9. An insulated switch pole for interruption of an electric current, comprising:
a dimensionally stable and electrically non-conductive dielectric housing;
a switching tube mounted in said housing and having a stationary fixed contact and a movably disposed moving contact;
an input connecting piece electrically connected to said fixed contact and enabling contact from outside said housing;
an outgoer connecting piece firmly connected to said housing and having a contact surface enabling contact from outside said housing, a moving contact connection connecting said outgoer connecting piece to said moving contact, and at least one connecting device acting on said contact surface and holding said moving contact connection against said outgoer connecting piece; and
said housing having an opening formed therein for introduction of a drive movement to said moving contact.

10. The insulated switch pole according to claim 9, wherein:
said at least one connecting device is one of a plurality of connecting devices; and
said outgoer connecting piece is formed with throughholes in said contact surface, and said connecting devices extend through said throughholes.

11. The insulated switch pole according to claim 9, wherein said at least one connecting device is one of a plurality of connecting devices and said connecting devices define a clamping connection.

12. The insulated switch pole according to claim 9, wherein said moving contact connection has at least one flexible strip.

13. The insulated switch pole according to claim 12, wherein said at least one flexible strip is one of a plurality of flexible strips connected to said outgoer connecting piece via a common intermediate piece.

14. A method of connecting a moving contact connection of an insulated switch pole, the method which comprises:
providing an insulated switch pole with a dimensionally stable, electrically non-conductive dielectric housing, a switching tube configured for mounting in the dielectric housing and having a stationary fixed contact and a moving contact, an input connecting piece electrically connected to the fixed contact and enabling contact to be made from outside the housing, and an outgoer connecting piece with a contact surface enabling contact to be made from outside the housing, the dielectric housing being formed with an opening for introduction of a drive movement to the moving contact;
introducing the switching tube into the dielectric housing; and
subsequently attaching a moving contact connection to the contact surface of the outgoer connecting piece for electrically connecting the outgoer connecting piece to the moving contact via the moving contact connection.

15. The method according to claim 14, wherein the attaching step comprises forming a clamping connection between the moving contact connection and the outgoer connecting piece.

16. The method according to claim 14, wherein the moving contact connection is attached by way of a plurality of flexible strips and a common intermediate piece.

17. A method of assembling an insulated switch pole, the method which comprises:
providing a dimensionally stable, electrically non-conductive dielectric housing formed with a cavity for intruding therein a switching tube and being formed with an opening for introduction of a drive movement to a moving contact of the switching tube;
providing the switching tube with a stationary fixed contact and a moving contact, an input connecting piece electrically connected to the fixed contact for contacting from outside the housing, and an outgoer connecting piece with a contact surface for contacting from outside the housing;
introducing the switching tube into the dielectric housing; and
subsequently attaching a moving contact connection to the contact surface of the outgoer connecting piece for electrically connecting the outgoer connecting piece to the moving contact via the moving contact connection.

18. The method according to claim 17, wherein the attaching step comprises forming a clamping connection between the moving contact connection and the outgoer connecting piece.

19. The method according to claim 17, wherein the moving contact connection is attached by way of a plurality of flexible strips and a common intermediate piece.
